(19) United States
(12) Patent Application Publication
(10) Pub. No.: US 2023/0406714 A1
(43) Pub. Date: Dec. 21, 2023

(54) SURFACE-MODIFIED TWO-DIMENSIONAL MXENE, AND METHOD FOR PRODUCING SAME

(71) Applicant: KOREA NATIONAL UNIVERSITY OF TRANSPORTATION INDUSTRY-ACADEMIC COOPERATION FOUNDATION, Chungju-si (KR)

(72) Inventors: In Sik IN, Chungju-si (KR); Jihoon LEE, Chungju-si (KR); So Yeon KIM, Sacheon-si (KR); Seong Min PARK, Haenam-eup (KR)

(21) Appl. No.: 18/037,352

(22) PCT Filed: Jan. 6, 2021
(86) PCT No.: PCT/KR2021/000154

§ 371 Date: May 17, 2023

(30) Foreign Application Priority Data
Nov. 17, 2020 (KR) 10-2020-0154061

(51) Int. Cl. C01B 32/921

(52) U.S. Cl. CPC C01B 32/921

(57) ABSTRACT

The present disclosure relates to a surface-modified two-dimensional MXene and a method for manufacturing the same, and in particular, to a surface-modified two-dimensional MXene having the surface modified with a compound including a hydroxyl group or an ionic compound, thereby preventing oxidation of MXene and improving dispersibility.

The present disclosure claims the benefit of Korean Patent Application No. 10-2020-0154061, filed with the Korean Intellectual Property Office on Nov. 17, 2020, the contents of which are incorporated herein by reference in their entirety.

The present disclosure has been made with the support of the Korean government in accordance with “development of light-responsive carbon nanomaterial-based transportation convergence material”, a university-focused research institute support program in the field of science and engineering having the project identification number 1345315501 and project number 2018R1A6A1A03023788 of the National Research Foundation under the Ministry of Education.

### TECHNICAL FIELD

The present disclosure relates to a surface-modified two-dimensional MXene and a method for manufacturing the same, and in particular, to a surface-modified two-dimensional MXene having the surface modified with a compound including a hydroxyl group or an ionic compound, thereby preventing oxidation of MXene and improving dispersibility.

### BACKGROUND

As one of three-dimensional materials having a structure similar to graphite, a MAX phase (herein, M is a transition metal including Sc, Ti, V, Cr, Zr, Nb, Mo, Hf and Ta, A is a group 13 or 14 element including Al, Si, P, S, Ga, Ge, As, Cd, In, Sn, Tl and Pb, and X is carbon and/or nitrogen) is a crystalline substance in which MX with quasi-ceramic properties and a metal element A different from M are combined, and has properties such that physical properties such as electrical conductivity, oxidation resistance and machinability are excellent.

In 2011, a new family of two-dimensional (2D) crystalline transition metal carbide called MXene having a general formula of M₍ₙ₊₁₎XₙTₓ was developed at Drexel University in the United States by selectively removing an aluminum layer from a three-dimensional titanium-aluminum carbide that is a MAX phase using hydrofluoric acid.

MXene has been recognized as a very useful material since it has excellent electrical conductivity and strength due to its metal-like properties, and is applicable to various application technologies such as sensors, capacitors, storage materials and electromagnetic shielding.

Generally, MXene reacts with an acid in an aqueous solution of strong acid to produce terminal groups such as —OH, —F, —Cl and ═O on the surface, and, particularly due to the —OH functional group among these, has hydrophilic properties.

MXene manufactured using a chemical etching process is readily dispersed in water due to the large amount of —OH functional group present on the surface. However, MXene dispersed in an aqueous solution phase is readily oxidized by water molecules and dissolved oxygen, and as a result, changes to a metal oxide and loses its original excellent properties, which makes long-term storage difficult. In addition, due to the surface hydrophilic properties, bonding force with other materials having hydrophobicity (polymers, organic materials) is low, which makes it difficult to form a composite material in a uniform state with organic monomers or organic polymers.

Accordingly, studies on a two-dimensional MXene modified to improve oxidation stability of the MXene for long-term storage, and to facilitate bonding with organic materials have been urgently required.

### SUMMARY

The present disclosure is directed to providing a surface-modified two-dimensional MXene capable of, by physically modifying a surface of the two-dimensional MXene with a compound including at least one hydroxyl group or an ionic compound, preventing oxidation caused by dissolved oxygen present in water, exhibiting excellent dispersibility in various organic solvents, and having excellent electrical conductivity, solution processability and coatability.

However, objects to be addressed by the present disclosure are not limited to the object mentioned above, and other objects not mentioned will be clearly appreciated by those skilled in the art from the following description.

One embodiment of the present disclosure provides a surface-modified two-dimensional MXene having an outer surface of the two-dimensional MXene modified with one selected from the group consisting of a compound including at least one hydroxyl group, an ionic compound and a combination thereof.

One embodiment of the present disclosure provides a method for manufacturing the surface-modified two-dimensional MXene, the method including: a first step of obtaining an aqueous MXene solution in which the two-dimensional MXene is dispersed using an acid etching process; a second step of preparing a mixture in which one selected from the group consisting of a compound including at least one hydroxyl group, an ionic compound and a combination thereof is dispersed in water or an organic solvent; and a third step of modifying an outer surface of the two-dimensional MXene by mixing the aqueous MXene solution obtained in the first step and the mixture of the second step and stirring the result.

A surface-modified two-dimensional MXene according to one embodiment of the present disclosure can be stably dispersed in water or various organic solvents depending on a compound including at least one hydroxyl group or an ionic compound used for the surface modification, and oxidation stability and long-term stability thereof can be improved.

A method for manufacturing the surface-modified two-dimensional MXene according to one embodiment of the present disclosure can readily modify the surface of the two-dimensional MXene.

Effects of the present disclosure are not limited to the above-described effects, and effects not mentioned will be clearly appreciated by those skilled in the art from the present specification and accompanying drawing.

### BRIEF DESCRIPTION OF DRAWINGS

FIG. 1 is a flow chart of a method for manufacturing a surface-modified two-dimensional MXene according to one embodiment of the present disclosure.

FIG. 2 is a schematic diagram illustrating a process for manufacturing the two-dimensional MXene.

FIG. 3 is a schematic diagram illustrating the surface-modified two-dimensional MXene according to one embodiment of the present disclosure being modified with a carboxylic acid-based compound.

FIG. 4 is a photograph showing dispersion of MXene inks of Example 1 and Comparative Example 1 depending on solvents.

FIG. 5 is a photograph taking a folding test result to identify flexibility of a thin film manufactured using Example 14.

FIG. 6 is a photograph showing contact angles of thin films manufactured according to Example 1 and Comparative Example 1 for water.

FIG. 7 is a photograph showing oxidation rate results of Example 6 and Comparative Example 1.

FIG. 8 is a graph showing wavelength-dependent absorbance of Example 5 and Comparative Example 1.

FIG. 9 is a graph showing XRD of Example 6 and Comparative Example 1.

### DETAILED DESCRIPTION

Throughout the present specification, a description of a certain part “including” certain constituents means capable of further including other constituents, and does not exclude other constituents unless particularly stated on the contrary.

Throughout the present specification, a description of a certain member being placed “on” another member includes not only a case of the certain member being in contact with the another member but a case of still another member being present between the two members.

Throughout the present specification, “A and/or B” means “A and B, or A or B”.

Hereinafter, the present disclosure will be described in more detail.

One embodiment of the present disclosure provides a surface-modified two-dimensional MXene having an outer surface of the two-dimensional MXene modified with a compound including at least one hydroxyl group, an ionic compound and a combination thereof.

The surface-modified two-dimensional MXene according to one embodiment of the present disclosure may be stably dispersed in water or various organic solvents depending on a compound including at least one hydroxyl group or an ionic compound used for the surface modification, and oxidation stability and long-term stability thereof may be improved.

According to one embodiment of the present disclosure, the two-dimensional MXene includes at least one or more layers in which a plurality of crystal cells having an empirical formula of Mₙ₊₁Xₙ form a two-dimensional array, each X is positioned in an octahedral array formed with a plurality of Ms, M is at least one metal selected from the group consisting of group IIIB metals, group IVB metals, group VB metals and group VIB metals, each X is one selected from among C, N and a combination thereof, and n may be 1, 2 or 3. By selecting the two-dimensional MXene from those described above, bonding force with the compound including a hydroxyl group or the ionic compound may be improved, and by the bonding, oxidation stability may be improved and electrical conductivity may be increased.

According to one embodiment of the present disclosure, the two-dimensional MXene includes at least one or more layers in which a plurality of crystal cells having an empirical formula of M′₂M″ₙXₙ₊₁ form a two-dimensional array, each X is positioned in an octahedral array formed with a plurality of M′s and M″s, M′ and M″ are metals different from each other and selected from the group consisting of group IIIB metals, group IVB metals, metal VB metals and group VIB metals, each X is C, N or a combination thereof, and n may be 1 or 2. By selecting the two-dimensional MXene from those described above, bonding force with the compound including a hydroxyl group or the ionic compound may be improved, and by the bonding, oxidation stability may be improved and electrical conductivity may be increased.

According to one embodiment of the present disclosure, the compound including a hydroxyl group may be one selected from the group consisting of a diol-based compound, a boronic acid-based compound, a carboxylic acid-based compound, a sulfonic acid-based compound, a sulfinic acid-based compound, a compound of the following Formula 1 and a combination thereof.

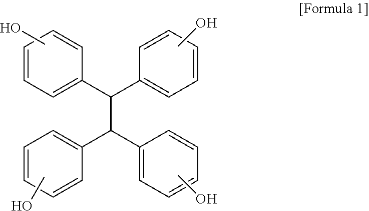

By selecting the compound including a hydroxyl group from those described above, solubility of the compound depending on an organic solvent may be changed, and bonding force for the surface of the two-dimensional MXene may be improved.

According to one embodiment of the present disclosure, the diol-based compound may be the following Formula 2.

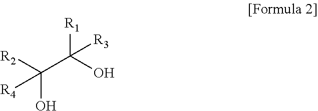

R₁, R₂, R₃ and R₄ are each hydrogen, a substituted or unsubstituted linear or branched alkyl group having 1 to 10 carbon atoms, a substituted or unsubstituted aryl group having 1 to 10 carbon atoms, a substituted or unsubstituted heterocycloalkene group having 3 to 7 carbon atoms, and a substituent represented by the following Formula 2a and Formula 2b.

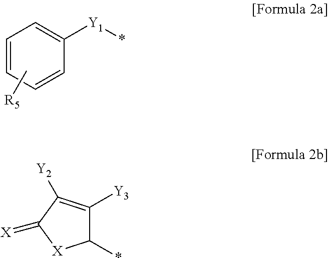

“*” means a connection point, Y₁ is O or S, Y₂ and Y₃ are each —F, —Cl, —Br, —I, —OH, —SH and —NR₆R₇R₈, and R₆, R₇ and R₈ are each hydrogen, a substituted or unsubstituted linear or branched alkyl group having 1 to 10 carbon atoms, a substituted or unsubstituted aryl group having 1 to 10 carbon atoms, and a substituted or unsubstituted heterocycloalkene group having 3 to 7 carbon atoms. By selecting the diol-based compound from those described above, oxidation stability of the surface-modified two-dimensional MXene may be improved, and dispersibility may be improved in various organic solvents.

According to one embodiment of the present disclosure, Formula 2 may be any one of the following Formula 2-1 to 2-5.

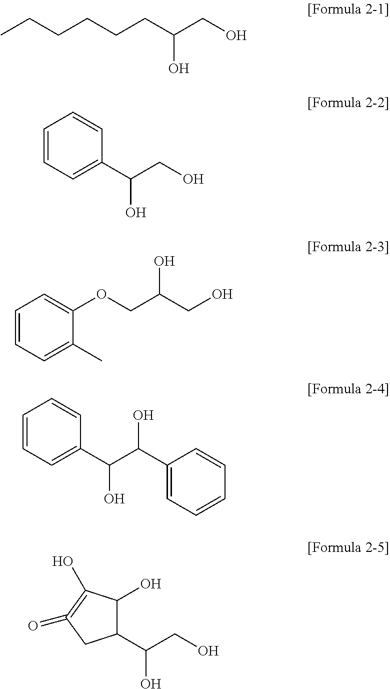

By selecting Formula 2 from those described above, the surface-modified two-dimensional MXene may be stably dispersed in water or various organic solvents, and oxidation stability and long-term stability may be improved.

According to one embodiment of the present disclosure, the boronic acid-based compound may be the following Formula 3.

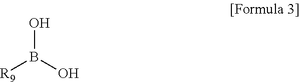

R₉ is a hydroxyl group, a substituted or unsubstituted linear or branched alkyl group having 1 to 10 carbon atoms, a substituted or unsubstituted linear or branched alkenyl group having 2 to 10 carbon atoms, a substituted or unsubstituted cycloalkyl group having 3 to 15 carbon atoms, a substituted or unsubstituted aryl group having 6 to 20 carbon atoms, a substituted or unsubstituted anthracenyl group, a substituted or unsubstituted pyrenyl group, a substituted or unsubstituted pyridinyl group, a substituted or unsubstituted thiophenyl group, a substituted or unsubstituted furanyl group, a substituted or unsubstituted pyrazolyl group and a substituted or unsubstituted pyrrolyl group. By selecting the boronic acid-based compound from those described above, the surface-modified two-dimensional MXene may be stably dispersed in water or various organic solvents, and oxidation stability and long-term stability may be improved.

According to one embodiment of the present disclosure, Formula 3 may be selected from the group consisting of the following Formula 3-1 to 3-42 and a combination thereof.

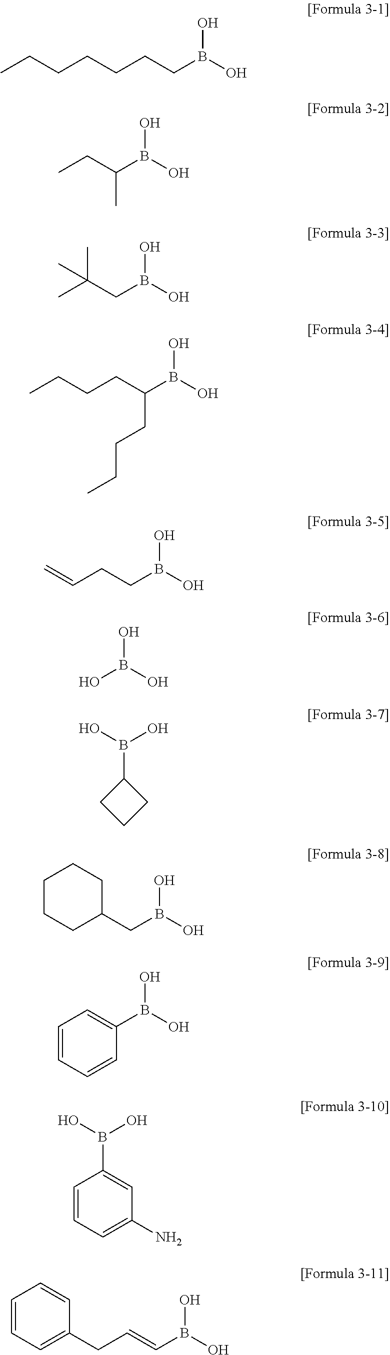

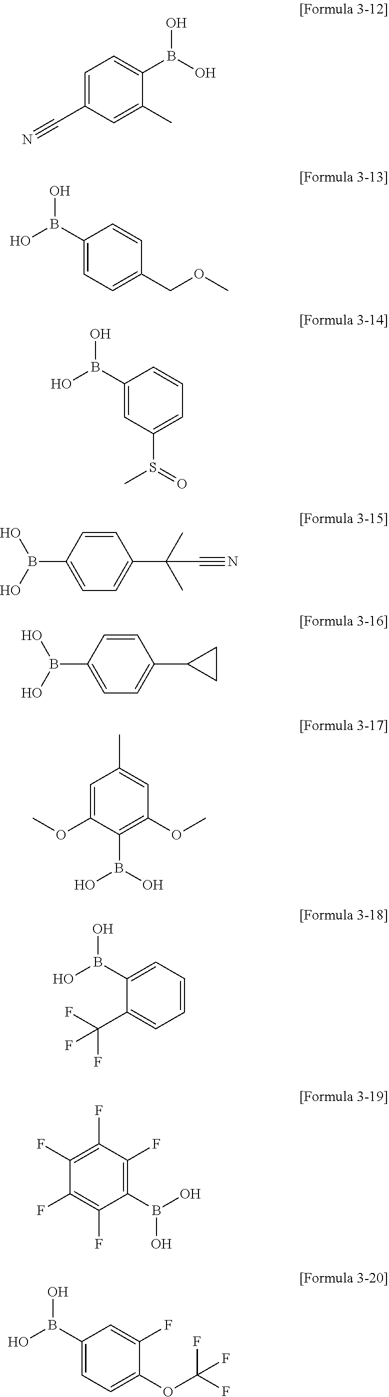

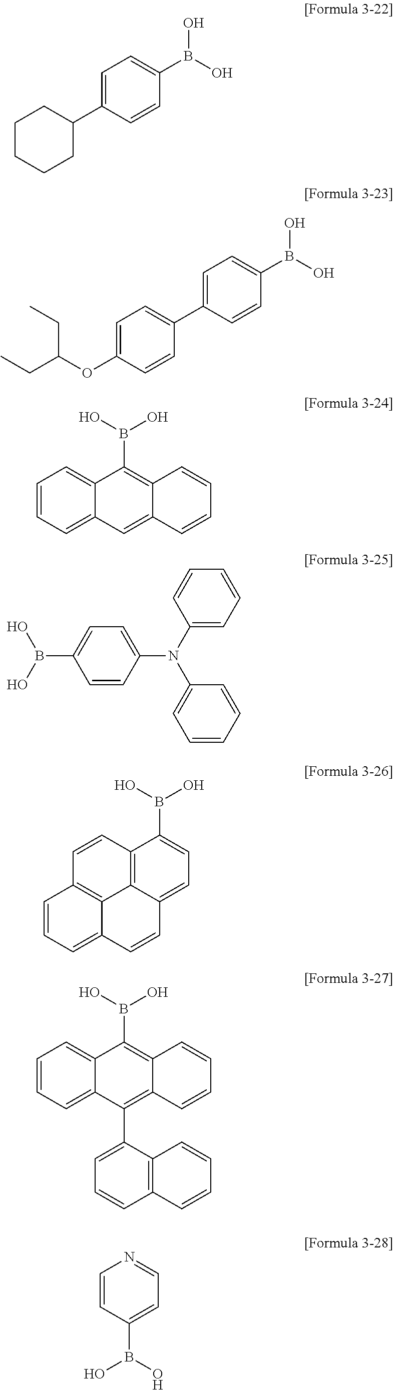

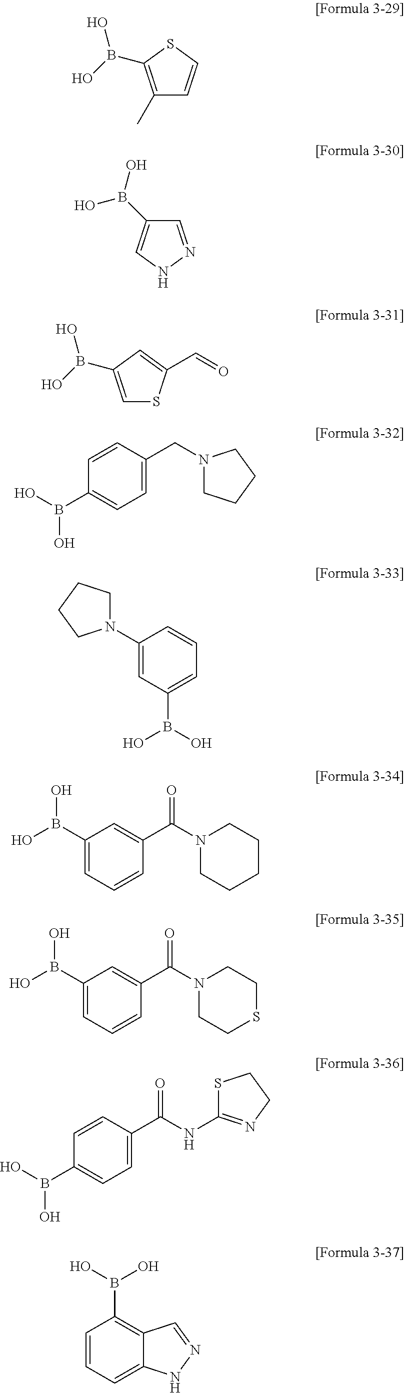

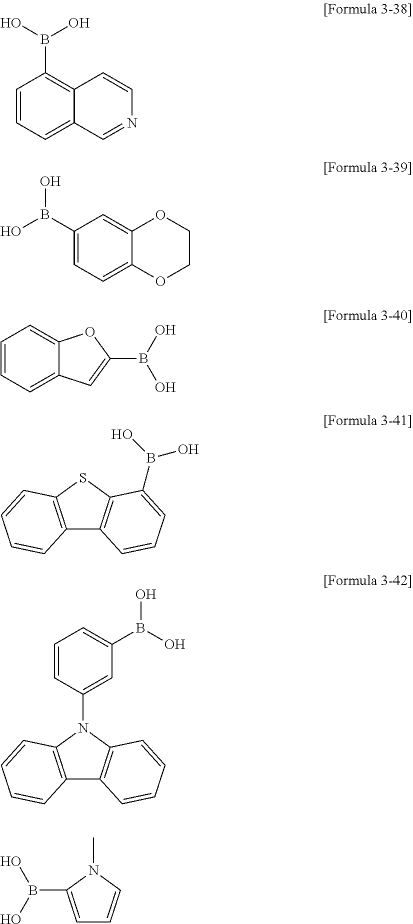

By selecting from Formula 3 from those described above, the surface modified two-dimensional MXene may be stably dispersed in water or various organic solvents, and oxidation stability and long-term stability may be improved.

According to one embodiment of the present disclosure, the carboxylic acid-based compound may be one selected from the group consisting of the following Formula 4, the Formula 4-1 to 4-3 and a combination thereof.

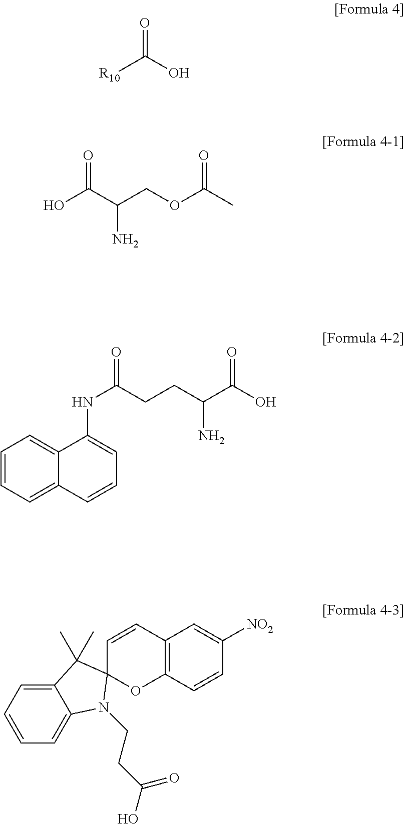

R₁₀ is a substituted or unsubstituted linear or branched alkyl group having 1 to 10 carbon atoms, a substituted or unsubstituted linear or branched alkenyl group having 2 to 10 carbon atoms, a substituted or unsubstituted linear or branched dienyl group having 2 to 10 carbon atoms, a substituted or unsubstituted cycloalkyl group having 3 to 15 carbon atoms, a substituted or unsubstituted aryl group having 6 to 20 carbon atoms, a substituted or unsubstituted anthracenyl group, a substituted or unsubstituted pyrenyl group, a substituted or unsubstituted pyridinyl group, a substituted or unsubstituted thiophenyl group, a substituted or unsubstituted furanyl group, a substituted or unsubstituted pyrazolyl group and a substituted or unsubstituted pyrrolyl group. By selecting the carboxylic acid-based compound from those described above, the surface-modified two-dimensional MXene may be stably dispersed in water or various organic solvents, and oxidation stability and long-term stability may be improved.

According to one embodiment of the present disclosure, Formula 4 may be selected from the group consisting of the following Formula 4-4 to 4-13 and a combination thereof.

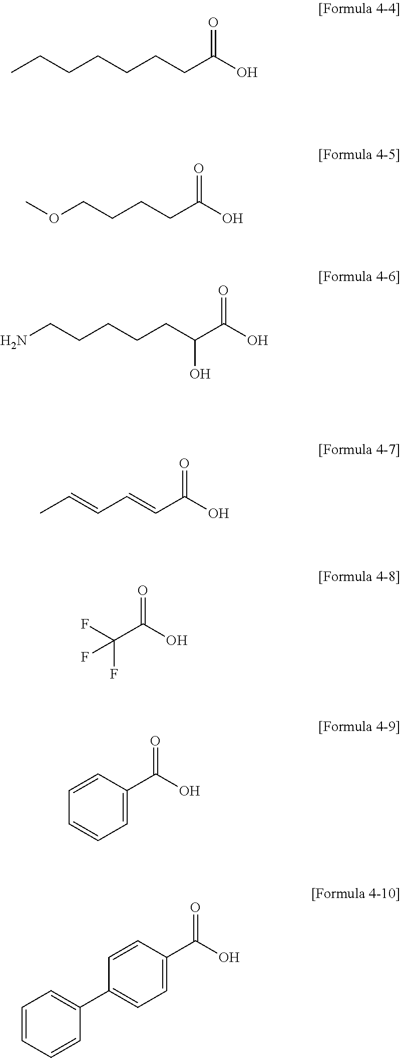

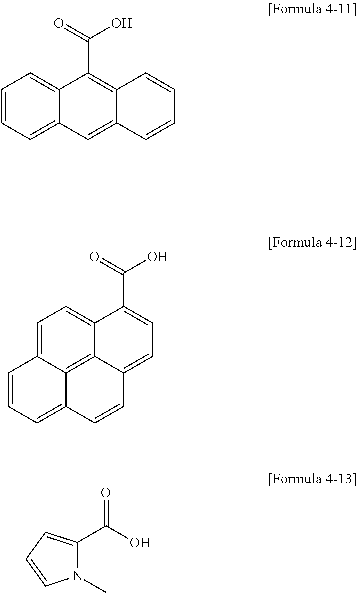

By selecting Formula 4 from those described above, the surface-modified two-dimensional MXene may be stably dispersed in water or various organic solvents, and oxidation stability and long-term stability may be improved.

According to one embodiment of the present disclosure, the sulfonic acid-based compound may be the following Formula 5.

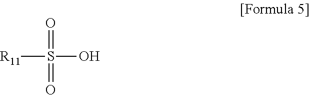

R₁₁ is a substituted or unsubstituted linear or branched alkyl group having 1 to 10 carbon atoms, a substituted or unsubstituted linear or branched alkenyl group having 2 to 10 carbon atoms, a substituted or unsubstituted linear or branched dienyl group having 2 to 10 carbon atoms, a substituted or unsubstituted cycloalkyl group having 3 to 15 carbon atoms, a substituted or unsubstituted aryl group having 6 to 20 carbon atoms, a substituted or unsubstituted anthracenyl group, a substituted or unsubstituted pyrenyl group, a substituted or unsubstituted pyridinyl group, a substituted or unsubstituted thiophenyl group, a substituted or unsubstituted furanyl group, a substituted or unsubstituted pyrazolyl group, a substituted or unsubstituted pyrrolyl group, a substituted or unsubstituted benzothiophenyl group, a substituted or unsubstituted benzimidazole group and a substituted or unsubstituted dihydrobenzofuran group. By selecting the sulfonic acid-based compound from those described above, the surface-modified two-dimensional MXene may be stably dispersed in water or various organic solvents, and oxidation stability and long-term stability may be improved.

According to one embodiment of the present disclosure, Formula 5 may be one selected from the group consisting of the following Formula 5-1 to 5-13 and a combination thereof.

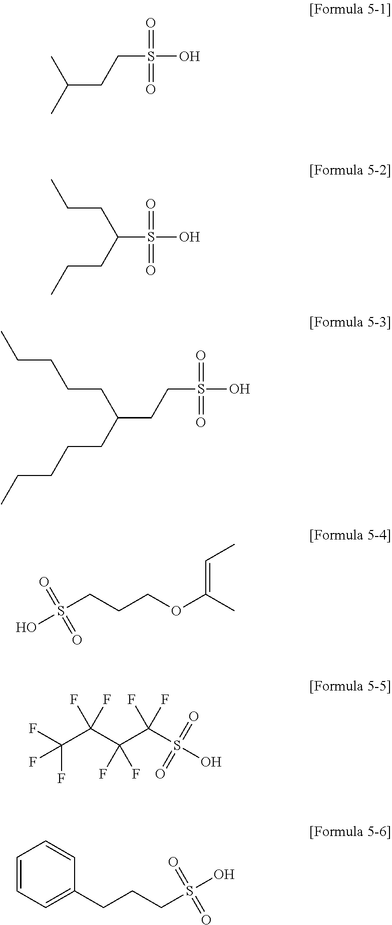

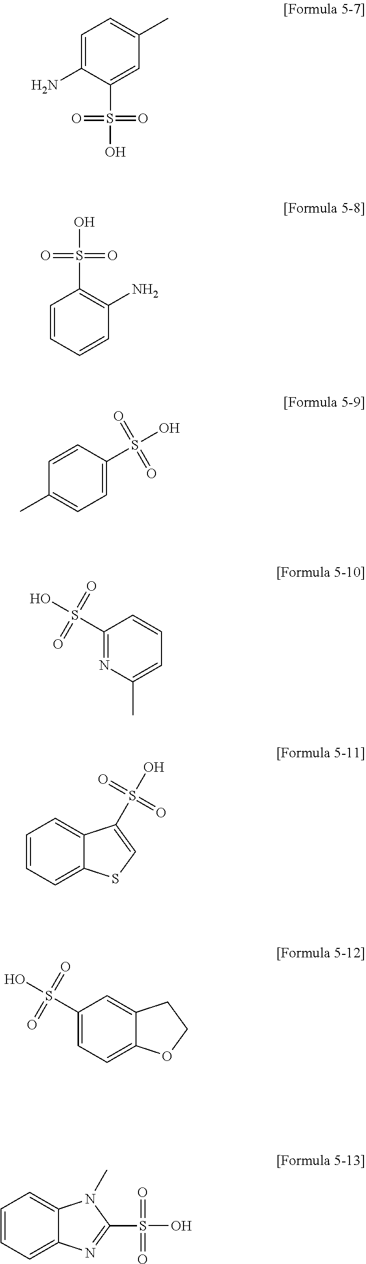

By selecting Formula 5 from those described above, the surface-modified two-dimensional MXene may be stably dispersed in water or various organic solvents, and oxidation stability and long-term stability may be improved.

According to one embodiment of the present disclosure, the sulfinic acid-based compound may be the following Formula 6.

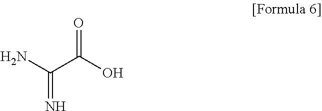

By selecting the sulfinic acid-based compound as described above, the surface-modified two-dimensional MXene may be stably dispersed in water or various organic solvents, and oxidation stability and long-term stability may be improved.

According to one embodiment of the present disclosure, the ionic compound may include a cation selected from the group consisting of an imidazolium-based compound, a pyridinium-based compound, an ammonium-based compound, a phosphinium-based compound and a combination thereof; and an anion selected from the group consisting of F⁻, Cl⁻, Br⁻, I, BF₄⁻, PF₆⁻, (CF₃SO₂)₂N⁻, CF₃SO₃⁻, C₂N₃⁻, CH₃SO₃⁻, CF₃BF₃⁻, C₂F₅BF₃⁻, NO₃⁻, CF₃CO₂⁻, C₃H₅O₃⁻, C₇H₅O₂⁻ and a combination thereof. By selecting the ionic compound from those described above, the surface-modified two-dimensional MXene may be stably dispersed in water or various organic solvents, and oxidation stability and long-term stability may be improved.

According to one embodiment of the present disclosure, the cation may be one selected from the group consisting of the following Formula 7 to 9 and a combination thereof.

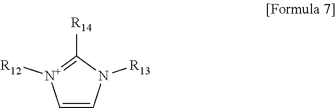

R₁₂, R₁₃ and R₁₄ are each hydrogen, a substituted or unsubstituted linear or branched alkyl group having 1 to 15 carbon atoms, and a substituted or unsubstituted linear or branched alkenyl group having 2 to 10 carbon atoms.

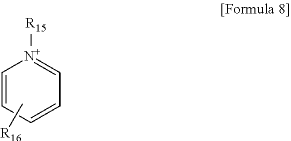

R₁₅ and R₁₆ are each hydrogen and a substituted or unsubstituted linear or branched alkyl group having 1 to 15 carbon atoms.

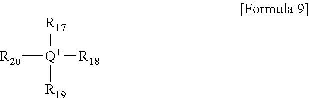

Q is N or P, and R₁₇, R₁₈, R₁₉ and R₂₀ are each a substituted or unsubstituted linear or branched alkyl group having 1 to 15 carbon atoms. By selecting the cation as described above, the surface-modified two-dimensional MXene may be stably dispersed in water or various organic solvents, and oxidation stability and long-term stability may be improved.

According to one embodiment of the present disclosure, Formula 7 may be one selected from the group consisting of the following Formula 7-1 to 7-13 and a combination thereof, Formula 8 may be one selected from the group consisting of the following Formula 8-1 and 8-2 and a combination thereof, and Formula 9 may be one selected from the group consisting of the following Formula 9-1 to 9-13 and a combination thereof.

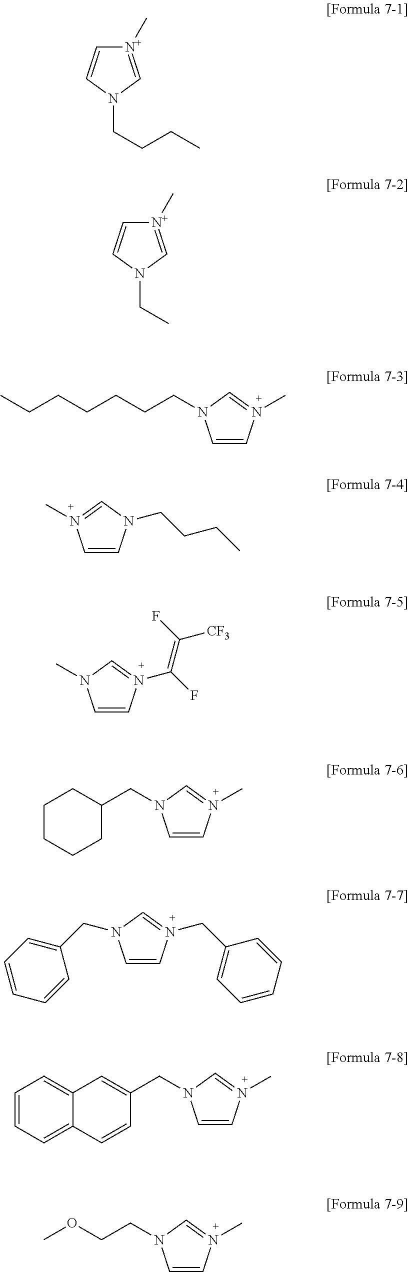

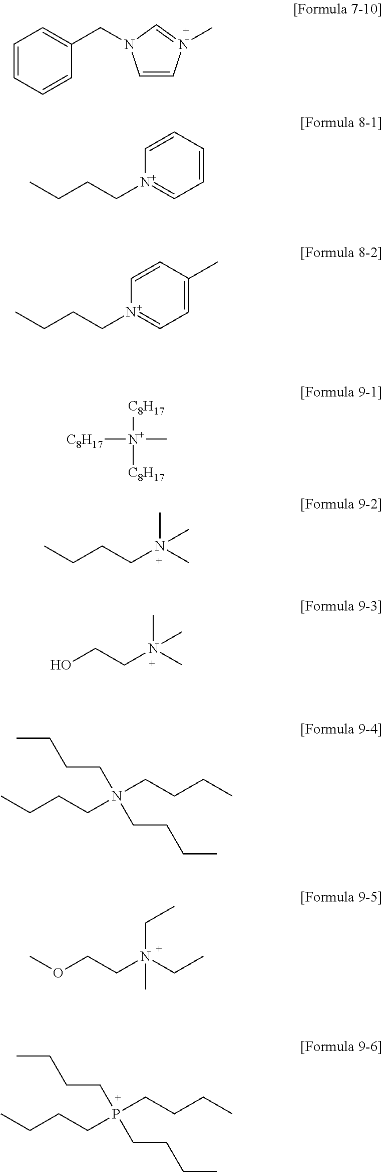

By selecting Formula 7, Formula 8 and Formula 9 from those described above, the surface-modified two-dimensional MXene may be stably dispersed in water or various organic solvents, and oxidation stability and long-term stability may be improved.

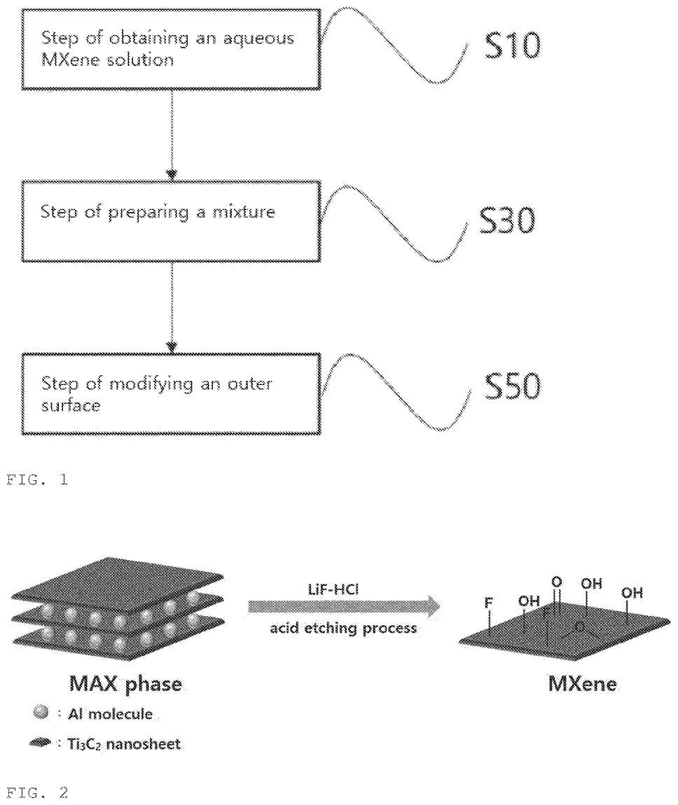

FIG. 1 is a flow chart of a method for manufacturing the surface-modified two-dimensional MXene according to one embodiment of the present disclosure. Referring to FIG. 1, one embodiment of the present disclosure provides a method for manufacturing the surface-modified two-dimensional MXene, the method including a first step (S10) of obtaining an aqueous MXene solution in which the two-dimensional MXene is dispersed using an acid etching process; a second step (S30) of preparing a mixture in which one selected from the group consisting of a compound including at least one hydroxyl group, an ionic compound and a combination thereof is dispersed in water or an organic solvent; and a third step (S50) of modifying an outer surface of the two-dimensional MXene by mixing the aqueous MXene solution obtained in the first step and the mixture of the second step and stirring the result.

The method for manufacturing the surface-modified two-dimensional MXene according to one embodiment of the present disclosure may readily modify the surface of the two-dimensional MXene.

In the present specification, descriptions overlapping with the descriptions provided above in the surface-modified two-dimensional MXene will not be included.

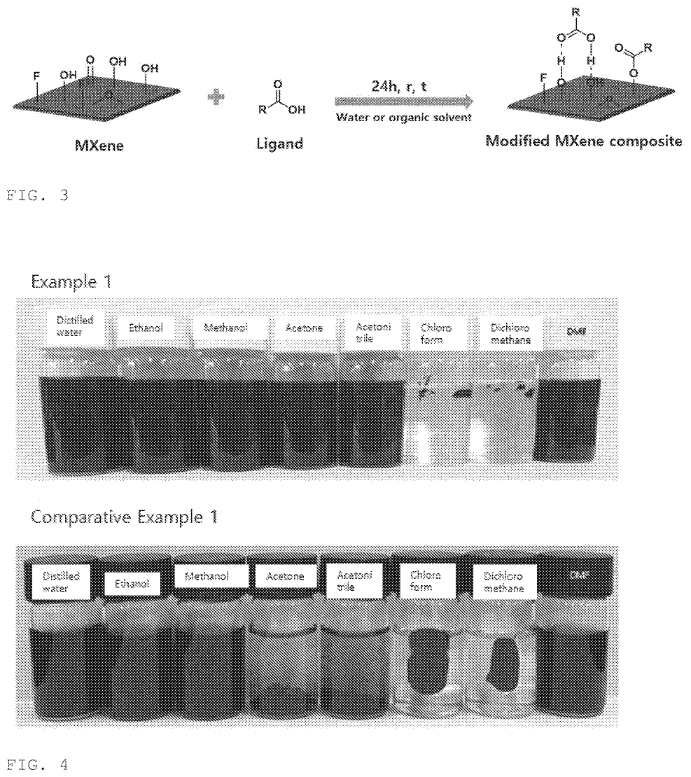

According to one embodiment of the present disclosure, the method includes a first step (S10) of obtaining an aqueous MXene solution in which the two-dimensional MXene is dispersed using an acid etching process. FIG. 2 is a schematic diagram illustrating the process for manufacturing the two-dimensional MXene. Referring to FIG. 2, from a three-dimensional titanium-aluminum carbide that is a MAX phase, MXene, a two-dimensional crystalline transition metal carbide having a general formula of M₍ₙ₊₁₎XₙTₓ, is prepared by selectively removing the aluminum layer using LiF—HCl. The two-dimensional MXene prepared using the above-described method includes a hydroxyl group, a fluoro group, a carbonyl group and/or an epoxy group on the surface. By obtaining the aqueous MXene solution in which the two-dimensional MXene is dispersed using an acid etching process as described above, a functional group capable of physically bonding to a compound including a hydroxyl group or an ionic compound may be sufficiently included on the surface.

According to one embodiment of the present disclosure, the method includes a second step (S30) of preparing a mixture in which one selected from the group consisting of a compound including at least one hydroxyl group, an ionic compound and a combination thereof is dispersed in water or an organic solvent. By dispersing one selected from the group consisting of a compound including at least one hydroxyl group, an ionic compound and a combination thereof in water or an organic solvent as described above, compatibility with the aqueous MXene solution and workability may be improved.

According to one embodiment of the present disclosure, the method includes a third step (S50) of modifying an outer surface of the two-dimensional MXene by mixing the aqueous MXene solution obtained in the first step and the mixture of the second step and stirring the result. FIG. 3 is a schematic diagram illustrating the surface-modified two-dimensional MXene according to one embodiment of the present disclosure being modified with a carboxylic acid-based compound. Referring to FIG. 3, it may be identified that, by mixing the aqueous MXene solution and the mixture and stirring the result, the carboxylic acid-based compound physically bonds to the two-dimensional MXene surface through hydrogen bonding as in FIG. 3. By modifying the outer surface of the two-dimensional MXene as described above, the two-dimensional MXene may be stably dispersed in water or various organic solvents, and oxidation stability and long-term stability may be improved, and electrical conductivity may be improved.

Hereinafter, the present disclosure will be described in detail with reference to examples in order to specifically describe the present disclosure. However, the examples according to the present disclosure may be modified to various different forms, and the scope of the present disclosure is not construed as being limited to the examples described below. The examples of the present specification are provided in order to more fully describe the present disclosure to those having average knowledge in the art.

### Preparation Example—Preparation of Aqueous MXene Solution

1 g of Ti₃AlC₂ powder (average particle size 40 μm) was introduced to 20 ml of a 9 M HCl (DAEJUNG, 35-37%) solution in which 1.6 g of LiF (Alfa Aesar, 98.5%) was dissolved, and an acidic solution obtained by stirring the result for 24 hours at room temperature was washed several times with deionized water using a centrifuge. An aqueous solution of separated MXene (Ti₃C₂Tₓ) was diluted to 1 mg/mL to prepare 35 mL of the solution.

### Comparative Example 1

The aqueous MXene solution itself prepared in Preparation Example was used as a MXene ink.

### Example 1

An aqueous solution was prepared by dissolving 35 mg of Formula 2-1 in 10 mL of tertiary purified distilled water. The aqueous MXene solution of Preparation Example and the aqueous solution in which Formula 2-1 was dissolved were mixed, and stirred for 24 hours at room temperature to proceed a reaction. After 24 hours, the stirring was stopped, and MXene of which surface was modified with Formula 2-1 was separated through a centrifuge (1736R model, GYROZEN Co. Ltd.), and washed 3 to 5 times with a solvent to substitute (distilled water, ethanol, methanol, acetone, acetonitrile, chloroform, dichloromethane, dimethylformamide) to prepare a MXene ink.

### Example 2

A MXene ink was prepared in the same manner as in Example 1 except that the MXene ink was prepared using Formula 3-1 instead of Formula 2-1.

### Example 3

A MXene ink was prepared in the same manner as in Example 1 except that the MXene ink was prepared using Formula 4-3 instead of Formula 2-1.

### Example 4

A MXene ink was prepared in the same manner as in Example 1 except that the MXene ink was prepared using Formula 4-1 instead of Formula 2-1.

### Example 5

A MXene ink was prepared in the same manner as in Example 1 except that the MXene ink was prepared using Formula 3-6 instead of Formula 2-1.

### Example 6

A MXene ink was prepared in the same manner as in Example 1 except that the MXene ink was prepared using Formula 4-8 instead of Formula 2-1.

### Example 7

A MXene ink was prepared in the same manner as in Example 1 except that the MXene ink was prepared using Formula 5-5 instead of Formula 2-1.

### Example 8

An organic solution was prepared by dissolving 35 mg of Formula 3-9 in 10 mL of ethanol. The aqueous MXene solution of Preparation Example and the organic solution in which Formula 3-9 was dissolved were mixed, and stirred for 24 hours at room temperature to proceed a reaction. After 24 hours, the stirring was stopped, and MXene of which surface was modified with Formula 3-9 was separated through a centrifuge (1736R model, GYROZEN Co. Ltd.), and washed 3 to 5 times with a solvent to substitute (distilled water, ethanol, methanol, acetone, acetonitrile, chloroform, dichloromethane, dimethylformamide) to prepare a MXene ink.

### Example 9

An organic solution was prepared by dissolving 35 mg of Formula 3-10 in 10 mL of acetone. The aqueous MXene solution of Preparation Example and the organic solution in which Formula 3-10 was dissolved were mixed, and stirred for 24 hours at room temperature to proceed a reaction. After 24 hours, the stirring was stopped, and MXene of which surface was modified with Formula 3-10 was separated through a centrifuge (1736R model, GYROZEN Co. Ltd.), and washed 3 to 5 times with a solvent to substitute (distilled water, ethanol, methanol, acetone, acetonitrile, chloroform, dichloromethane, dimethylformamide) to prepare a MXene ink.

### Example 10

A MXene ink was prepared in the same manner as in Example 9 except that the MXene ink was prepared using Formula 3-22 instead of Formula 3-10.

### Example 11

An organic solution was prepared by dissolving 35 mg of Formula 4-11 in 10 mL of chloroform. The aqueous MXene solution of Preparation Example and the organic solution in which Formula 4-11 was dissolved were mixed, and stirred for 24 hours at room temperature to proceed a reaction. After 24 hours, the stirring was stopped, and MXene of which surface was modified with Formula 4-11 was separated through a centrifuge (1736R model, GYROZEN Co. Ltd.), and washed 3 to 5 times with a solvent to substitute (distilled water, ethanol, methanol, acetone, acetonitrile, chloroform, dichloromethane, dimethylformamide) to prepare a MXene ink.

### Example 12

An organic solution was prepared by dissolving 35 mg of Formula 3-24 in 10 mL of toluene. The aqueous MXene solution of Preparation Example and the organic solution in which Formula 3-24 was dissolved were mixed, and stirred for 24 hours at room temperature to proceed a reaction. After 24 hours, the stirring was stopped, and MXene of which surface was modified with Formula 3-24 was separated through a centrifuge (1736R model, GYROZEN Co. Ltd.), and washed 3 to 5 times with a solvent to substitute (distilled water, ethanol, methanol, acetone, acetonitrile, chloroform, dichloromethane, dimethylformamide) to prepare a MXene ink.

### Example 13

An organic solution was prepared by dissolving 35 mg of Formula 3-25 in 10 mL of ethanol. The aqueous MXene solution of Preparation Example and the organic solution in which Formula 3-25 was dissolved were mixed, and stirred for 24 hours at room temperature to proceed a reaction. After 24 hours, the stirring was stopped, and MXene of which surface was modified with Formula 3-25 was separated through a centrifuge (1736R model, GYROZEN Co. Ltd.), and washed 3 to 5 times with a solvent to substitute (distilled water, ethanol, methanol, acetone, acetonitrile, chloroform, dichloromethane, dimethylformamide) to prepare a MXene ink.

### Example 14

A MXene ink was prepared in the same manner as in Example 9 except that the MXene ink was prepared using Formula 4-3 instead of Formula 3-10.

### Example 15

A MXene ink was prepared in the same manner as in Example 13 except that the MXene ink was prepared using Formula 2-5 instead of Formula 3-25.

### Example 16

A MXene ink was prepared in the same manner as in Example 9 except that the MXene ink was prepared using Formula 7-9 instead of Formula 3-10 as a cation and [(CF₃SO₂)₂N⁻] as an anion.

### Example 17

An organic solution was prepared by dissolving 35 mg of an ionic compound, which includes a cation of Formula 7-6 and an anion of [(CF₃SO₂)₂N⁻] in 10 mL of acetonitrile. The aqueous MXene solution of Preparation Example and the organic solution in which the ionic compound was dissolved were mixed, and stirred for 24 hours at room temperature to proceed a reaction. After 24 hours, the stirring was stopped, and MXene of which surface was modified with the ionic compound was separated through a centrifuge (1736R model, GYROZEN Co. Ltd.), and washed 3 to 5 times with a solvent to substitute (distilled water, ethanol, methanol, acetone, acetonitrile, chloroform, dichloromethane, dimethylformamide) to prepare a MXene ink.

### Example 18

A MXene ink was prepared in the same manner as in Example 17 except that the MXene ink was prepared using an ionic compound including Formula 7-10 as a cation and [(CF₃SO₂)₂N⁻] as an anion instead of the ionic compound used in Example 17.

### Example 19

A MXene ink was prepared in the same manner as in Example 17 except that the MXene ink was prepared using an ionic compound including Formula 9-2 as a cation and [(CF₃SO₂)₂N⁻] as an anion instead of the ionic compound used in Example 17.

### Experimental Example 1 (Identification of Dispersibility of MXene Ink)

Dispersibility of the MXene ink prepared in each of Examples 1 to 19 for distilled water, ethanol, methanol, acetone, acetonitrile, chloroform, dichloromethane and DMF (dimethylformamide) was measured using UV-vis (V770 model, Jasco, Inc.), and the results are summarized in the following Table 1.

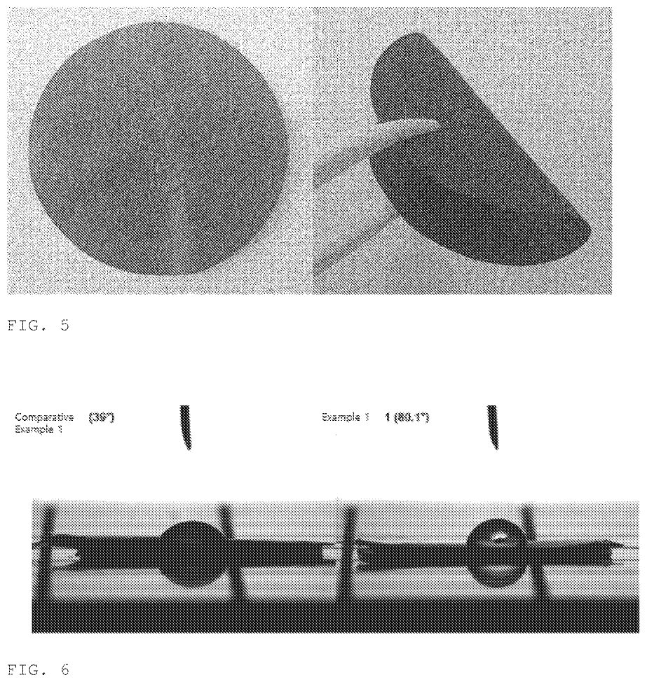

In addition, FIG. 4 is a photograph showing dispersion of the MXene inks of Example 1 and Comparative Example 1 depending on the solvents. Referring to FIG. 4, the MXene ink of Example 1 and the aqueous MXene solution of Comparative Example 1 were each dispersed in distilled water, ethanol, methanol, acetone, acetonitrile, chloroform, dichloromethane and DMF (dimethylformamide).

It was identified that Example 1 had excellent dispersibility for distilled water, ethanol, methanol, acetone, acetonitrile and DMF (dimethylformamide) and stably and uniformly dispersed in more various organic solvents, whereas Comparative Example 1 had excellent dispersibility for only distilled water, ethanol, methanol and DMF (dimethylformamide).

### Experimental Example 2 (Manufacture of Thin Film Using MXene Ink)

A thin film was manufactured from the MXene ink of which surface was modified according to each of Examples 1 to 19 using an anodic aluminum oxide film (pore size: 200 μm) and a filtration method.

FIG. 5 is a photograph taking a folding test result to identify flexibility of the thin film manufactured using Example 14. It was identified that, as shown in FIG. 5, the thin films manufactured from the MXene inks of Examples 1 to 19 had a thickness of 7 μm and had excellent flexibility.

### Experimental Example 3 (Measurement of Electrical Conductivity of Thin Film Manufactured Using MXene Ink)

Electrical conductivity of each of the thin films manufactured using the aqueous and organic MXene inks prepared from Examples 1 to 19 was calculated using a calculation formula (electrical conductivity=1/sheet resistance₁thickness) from a value measured using a sheet resistance meter (CMT-SR2000N model, AiT Co., Ltd.), and the results are summarized in the following Table 1.

TABLE 1

| | | Electrical | | | | | | | | |
|---|---|---|---|---|---|---|---|---|---|---|
| | | Conductivity | Dispersibility (High, Medium, Low) | | | | | | | |
| Category | Type | (S/cm) | (1) | (2) | (3) | (4) | (5) | (6) | (7) | (8) |
| Comparative | Aqueous | Avg. | High | Low | Medium | Low | Low | Low | Low | Medium |
| Example | MXene | 3,010 | | | | | | | | |
| | Solution | | | | | | | | | |
| Example | Formula 2-1 | 5,369 | High | High | High | High | High | Low | Low | High |
| 1 | | | | | | | | | | |
| Example | Formula 3-1 | 5,213 | High | High | High | High | High | Low | Low | High |
| 2 | | | | | | | | | | |
| Example | Formula 4-3 | 5,266 | High | High | High | High | High | Low | Low | High |
| 3 | | | | | | | | | | |
| Example | Formula 4-1 | 4,849 | High | Medium | Medium | Medium | Medium | Low | Low | High |
| 4 | | | | | | | | | | |
| Example | Formula 3-6 | 5,981 | High | Medium | Medium | Low | Low | Low | Low | Medium |
| 5 | | | | | | | | | | |
| Example | Formula 4-8 | 9,558 | High | High | High | Medium | High | Low | Low | High |
| 6 | | | | | | | | | | |
| Example | Formula 5-5 | 6,579 | High | High | High | High | High | Low | Low | High |
| 7 | | | | | | | | | | |
| Example | Formula 3-9 | 3,571 | High | Low | Low | Medium | Medium | Low | Low | Medium |
| 8 | | | | | | | | | | |
| Example | Formula 3-10 | 3,093 | High | Low | Low | Medium | Medium | Low | Low | Medium |
| 9 | | | | | | | | | | |
| Example | Formula 3-22 | 3,817 | Medium | Low | Low | Medium | Medium | Medium | Medium | Medium |
| 10 | | | | | | | | | | |
| Example | Formula 4-11 | 3,726 | Low | Low | Low | Medium | Medium | Medium | Medium | Medium |
| 11 | | | | | | | | | | |
| Example | Formula 3-24 | 3,108 | Low | Low | Low | Medium | Medium | Medium | Medium | Low |
| 12 | | | | | | | | | | |
| Example | Formula 3-25 | 3,053 | Low | Low | Low | Medium | Medium | Medium | Medium | Low |
| 13 | | | | | | | | | | |
| Example | Formula 4-3 | 3,047 | Low | Medium | Medium | Medium | High | Medium | Medium | Medium |
| 14 | | | | | | | | | | |
| Example | Formula 2-5 | 3,135 | Medium | Medium | Medium | Medium | High | Low | Low | Medium |
| 15 | | | | | | | | | | |
| Example | Formula 7-9 | 3,823 | Medium | High | Medium | Medium | High | High | Medium | Medium |
| 16 | and | | | | | | | | | |
| | [(CF₃SO₂)₂N⁻] | | | | | | | | | |
| Example | Formula 7-6 | 4,563 | Low | Low | Low | Medium | High | High | High | Medium |
| 17 | and | | | | | | | | | |
| | [(CF₃SO₂)₂N⁻] | | | | | | | | | |
| Example | Formula 7-10 | 4,333 | Low | Low | Low | Medium | High | High | High | Medium |
| 18 | and | | | | | | | | | |
| | [(CF₃SO₂)₂N⁻] | | | | | | | | | |
| Example | Formula 9-2 | 3,371 | Medium | Medium | Medium | High | Medium | Medium | Medium | Medium |
| 19 | and | | | | | | | | | |
| | [(CF₃SO₂)₂N⁻] | | | | | | | | | |

In Table 1, (1) means distilled water, (2) means ethanol, (3) means methanol, (4) means acetone, (5) means acetonitrile, (6) means chloroform, (7) means dichloromethane, and (8) means dimethylformamide. From the results of Table 1, it can be identified that electrical conductivity of the surface-modified two-dimensional MXene according to one embodiment of the present disclosure all corresponds to at least 3,053 S/cm or greater, which is an equal or higher value compared to inherent electrical conductivity of Comparative Example 1 that is a two-dimensional MXene before surface modification, and properties are significantly improved.

### Experimental Example 4 (Comparison of Contact Angle for Water Before and After Surface Modification)

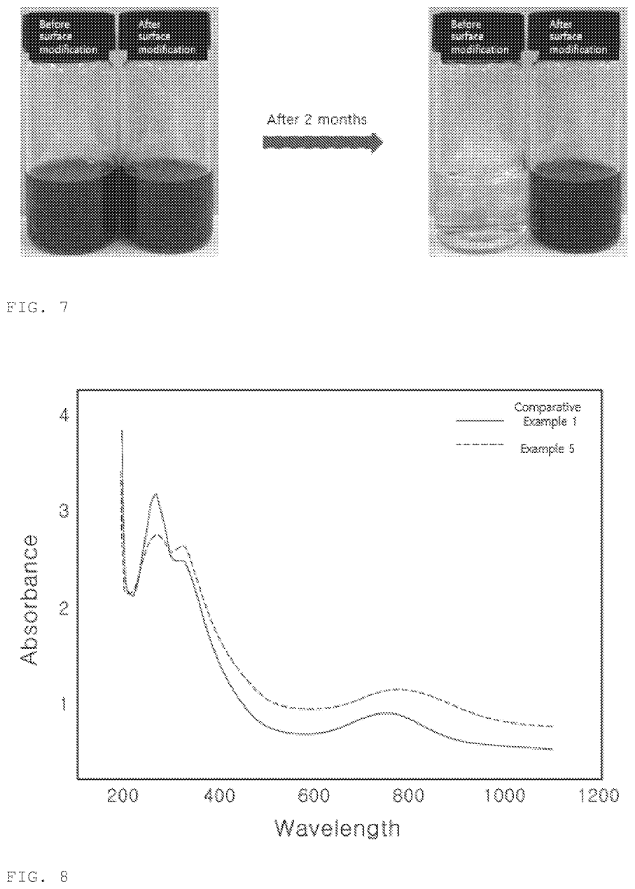

On the MXene film (Ti₃C₂Tₓ) manufactured using Comparative Example 1 and the MXene film manufactured using Example 1, distilled water was dropped, and the result of comparing the contact angles is shown in FIG. 6.

FIG. 6 is a photograph showing contact angles of the thin films manufactured according to Example 1 and Comparative Example 1 for water. As shown in FIG. 6, it can be identified that the MXene manufactured using Example 1 is more hydrophobic compared to the MXene manufactured using Comparative Example 1 which is hydrophilic. In other words, it can be seen that the MXene having the surface modified with the compound having a hydrophobic group like Formula 2-1 is slightly more hydrophobic. As a result, it was identified that surface modification of the MXene surface was successful.

### Experimental Example 5 (Comparison of Oxidation Rate Before and After Surface Modification)

The aqueous MXene solution (Ti₃C₂Tₓ) according to Comparative Example 1 and the MXene organic ink having the surface modified with the compound of Formula 4-8 according to Example 6 and then dispersed in ethanol were left unattended for two months, and the result of comparing the oxidation states is shown in FIG. 7.

FIG. 7 is a photograph showing the oxidation rate results of Example 6 and Comparative Example 1. Referring to FIG. 7, it was identified that oxidization did not occur well with the MXene ink of Example 6 even as time passed, whereas it was identified that the oxidation rate rapidly increased with Comparative Example 1 and most of them were oxidized and changed to a transparent solution state.

In all of Examples 1 to 5 and Examples 7 to 19, it was commonly identified that oxidation did not occur well even as time passed.

As a result, it was identified that the surface-modified two-dimensional MXene ink according to one embodiment of the present disclosure had very superior oxidation stability and improved long-term storage stability compared to the MXene that is not surface modified.

### Experimental Example 6 (Comparison of UV-Vis Absorbance Before and After Surface Modification)

For the surface-modified two-dimensional MXene according to Example 5 and the MXene of Comparative Example 1, absorbance was analyzed using UV-vis.

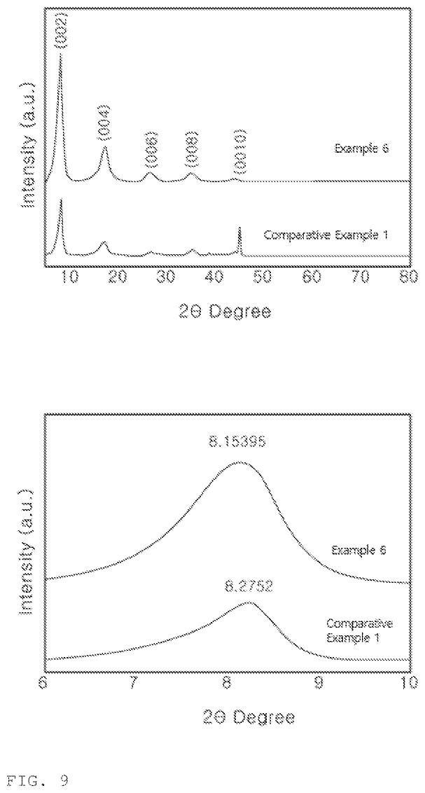

FIG. 8 is a graph showing wavelength-dependent absorbance of Example 5 and Comparative Example 1. Referring to FIG. 8, it was identified that, from the fact that the absorption peak of 300 nm or less (absorption peak of TiO₂) did not increase in Example 5 compared to in Comparative Example 1 and the MXene surface plasmon resonance peak near 760 nm was maintained, additional oxidation did not occur well with the surface-modified two-dimensional MXene.

### Experimental Example 7 (Comparison of XRD Before and After Surface Modification)

FIG. 9 is a graph showing XRD of Example 6 and Comparative Example 1. Referring to FIG. 9, it can be identified that a 2D stacking structure of the MXene is well maintained even after the surface modification, and from the shift of the (002) peak to the left due to the compound bonding to the surface after the surface modification, the d-spacing becomes slightly bigger.

According to the surface-modified two-dimensional MXene that is one embodiment of the present disclosure and a method for manufacturing the same, electrical conductivity may be maintained while preventing oxidation and improving dispersibility in various organic solvents by modifying the two-dimensional MXene surface with a compound including a hydroxyl group.

Hereinbefore, the present disclosure has been described with limited examples, however, the present disclosure is not limited thereto, and it is obvious that various changes and modifications may be made by those skilled in the art within technical ideas of the present disclosure and the range of equivalents of the claims to be described.

1. A surface-modified two-dimensional MXene having an outer surface of the two-dimensional MXene modified with one selected from the group consisting of a compound including at least one hydroxyl group, an ionic compound and a combination thereof.

2. The surface-modified two-dimensional MXene of claim 1, wherein the two-dimensional MXene includes at least one or more layers in which a plurality of crystal cells having an empirical formula of Mₙ₊₁Xₙ form a two-dimensional array,
each X is positioned in an octahedral array formed with a plurality of Ms;
M is at least one metal selected from the group consisting of group IIIB metals, group IVB metals, group VB metals and group VIB metals;
each X is one selected from among C, N and a combination thereof; and
n is 1, 2 or 3.

3. The surface-modified two-dimensional MXene of claim 1, wherein the two-dimensional MXene includes at least one or more layers in which a plurality of crystal cells having an empirical formula of M′₂M″ₙXₙ₊₁ form a two-dimensional array,
each X is positioned in an octahedral array formed with a plurality of M′s and M″s;
M′ and M″ are metals different from each other and selected from the group consisting of group IIIB metals, group IVB metals, metal VB metals and group VIB metals;
each X is C, N or a combination thereof; and
n is 1 or 2.

4. The surface-modified two-dimensional MXene of claim 1, wherein the compound including a hydroxyl group is one selected from the group consisting of a diol-based compound, a boronic acid-based compound, a carboxylic acid-based compound, a sulfonic acid-based compound, a sulfinic acid-based compound, a compound of the following Formula 1 and a combination thereof:

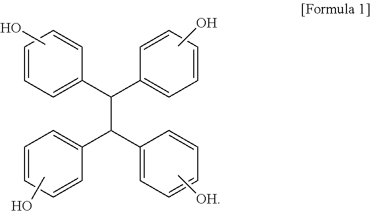

5. The surface-modified two-dimensional MXene of claim 4, wherein the diol-based compound is the following Formula 2: 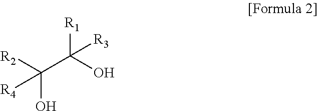
R₁, R₂, R₃ and R₄ are each hydrogen, a substituted or unsubstituted linear or branched alkyl group having 1 to 10 carbon atoms, a substituted or unsubstituted aryl group having 1 to 10 carbon atoms, a substituted or unsubstituted heterocycloalkene group having 3 to 7 carbon atoms, and a substituent represented by the following Formula 2a and Formula 2b, 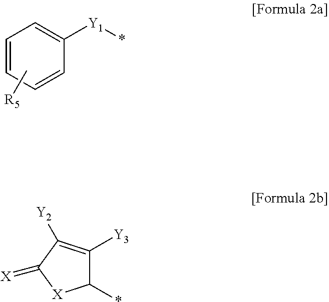
“*” means a connection point;
Y₁ is O or S;
Y₂ and Y₃ are each —F, —Cl, —Br, —I, —OH, —SH and —NR₆R₇R₈; and
R₆, R₇ and R₈ are each hydrogen, a substituted or unsubstituted linear or branched alkyl group having 1 to 10 carbon atoms, a substituted or unsubstituted aryl group having 1 to 10 carbon atoms, and a substituted or unsubstituted heterocycloalkene group having 3 to 7 carbon atoms.

6. The surface-modified two-dimensional MXene of claim 5, wherein Formula 2 is any one of the following Formula 2-1 to 2-5:

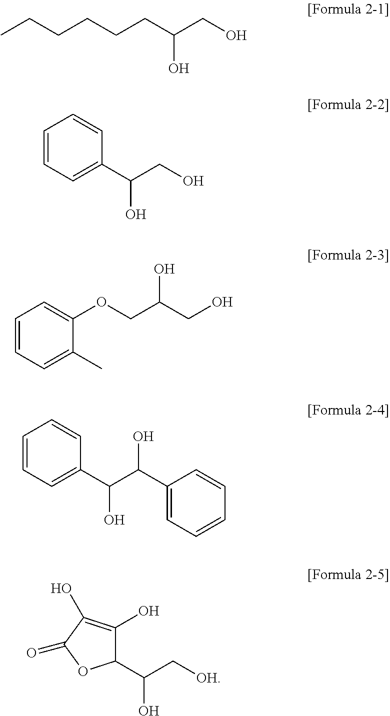

7. The surface-modified two-dimensional MXene of claim 4, wherein the boronic acid-based compound is the following Formula 3: 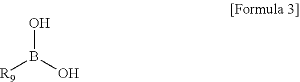
R₉ is a hydroxyl group, a substituted or unsubstituted linear or branched alkyl group having 1 to 10 carbon atoms, a substituted or unsubstituted linear or branched alkenyl group having 2 to 10 carbon atoms, a substituted or unsubstituted cycloalkyl group having 3 to 15 carbon atoms, a substituted or unsubstituted aryl group having 6 to 20 carbon atoms, a substituted or unsubstituted anthracenyl group, a substituted or unsubstituted pyrenyl group, a substituted or unsubstituted pyridinyl group, a substituted or unsubstituted thiophenyl group, a substituted or unsubstituted furanyl group, a substituted or unsubstituted pyrazolyl group and a substituted or unsubstituted pyrrolyl group.

8. The surface-modified two-dimensional MXene of claim 7, wherein Formula 3 is selected from the group consisting of the following Formula 3-1 to 3-42 and a combination thereof:

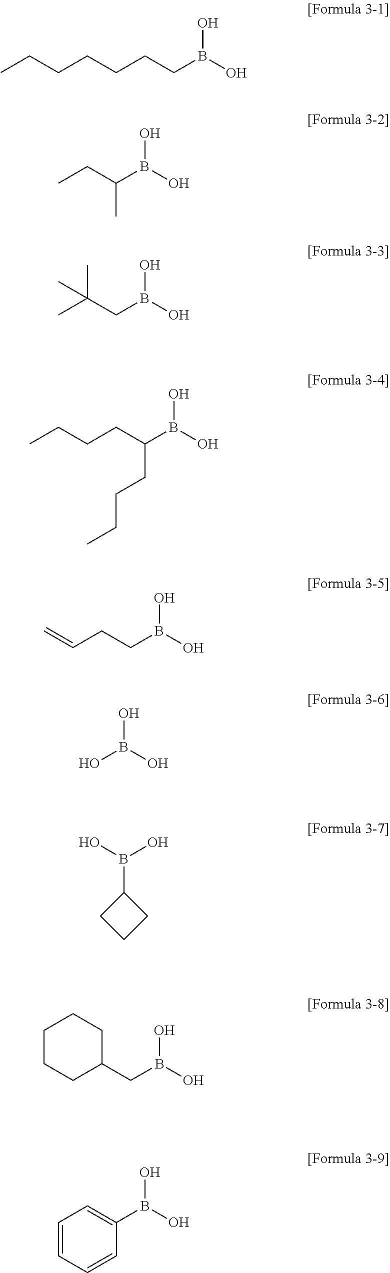

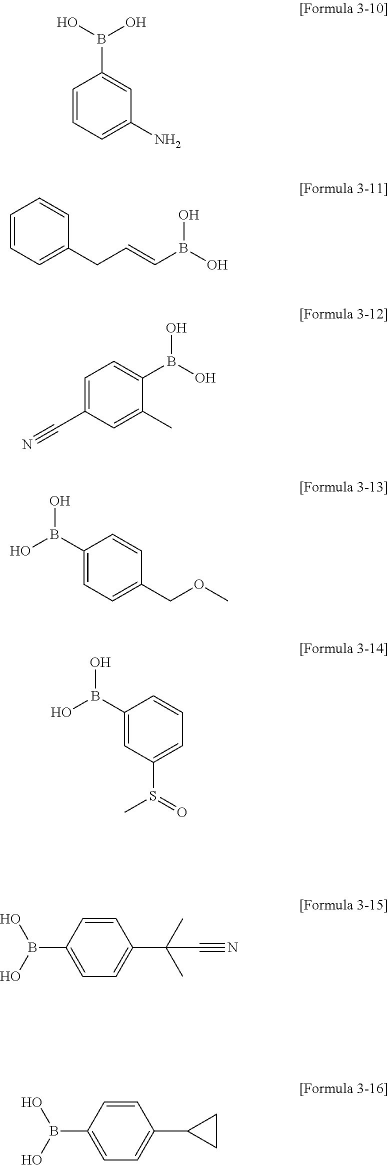

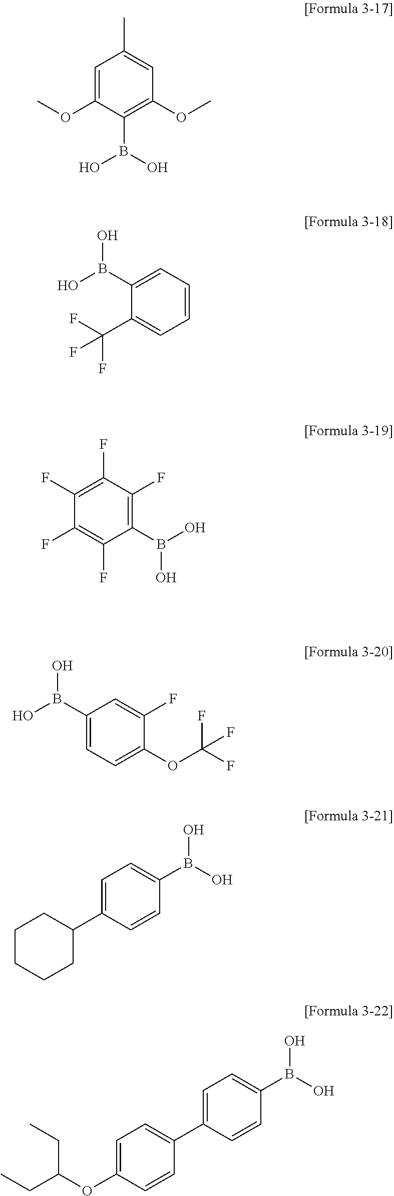

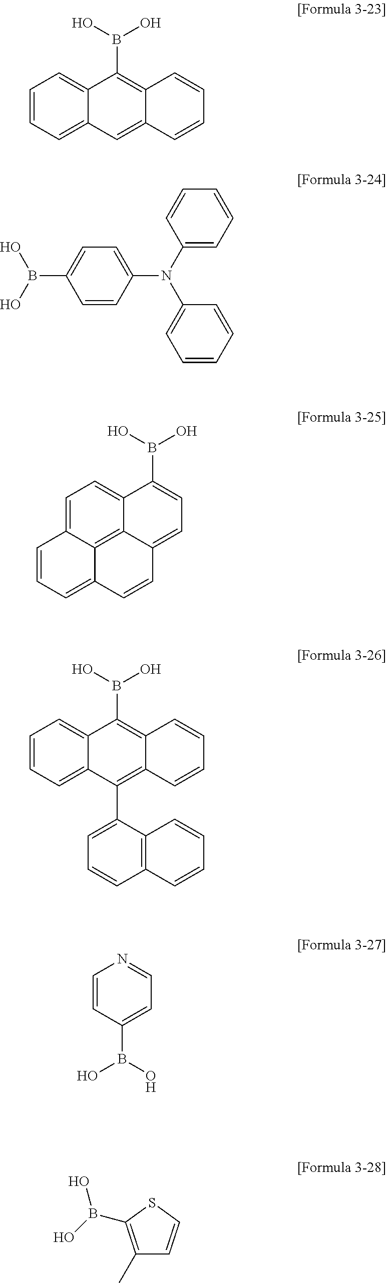

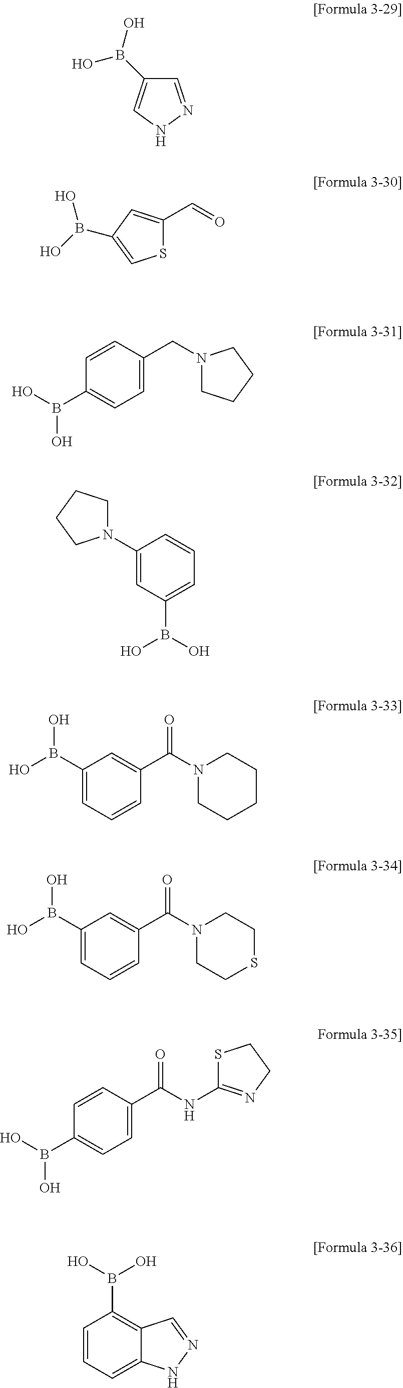

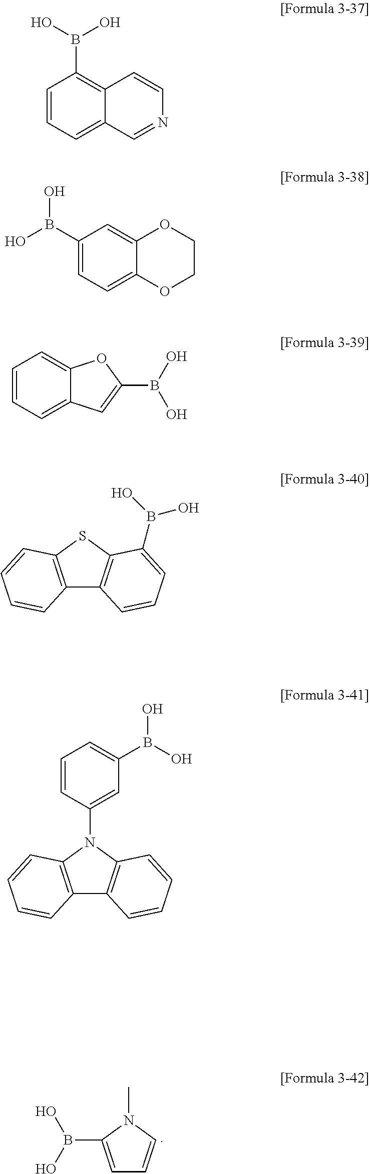

9. The surface-modified two-dimensional MXene of claim 4, wherein the carboxylic acid-based compound is one selected from the group consisting of the following Formula 4, the following Formulae 4-1 to 4-3 and a combination thereof: 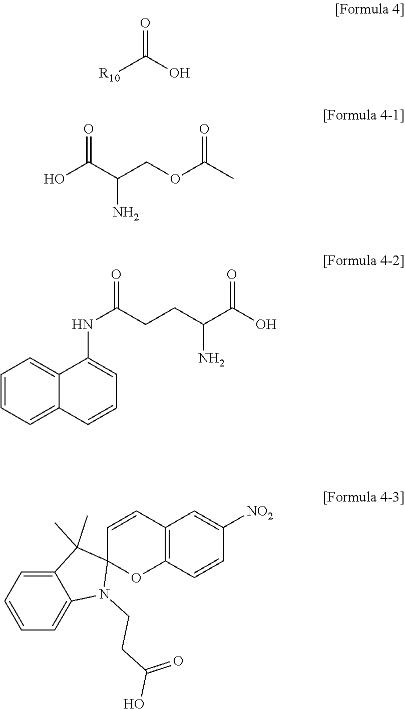
R₁₀ is a substituted or unsubstituted linear or branched alkyl group having 1 to 10 carbon atoms, a substituted or unsubstituted linear or branched alkenyl group having 2 to 10 carbon atoms, a substituted or unsubstituted linear or branched dienyl group having 2 to 10 carbon atoms, a substituted or unsubstituted cycloalkyl group having 3 to 15 carbon atoms, a substituted or unsubstituted aryl group having 6 to 20 carbon atoms, a substituted or unsubstituted anthracenyl group, a substituted or unsubstituted pyrenyl group, a substituted or unsubstituted pyridinyl group, a substituted or unsubstituted thiophenyl group, a substituted or unsubstituted furanyl group, a substituted or unsubstituted pyrazolyl group and a substituted or unsubstituted pyrrolyl group.

10. The surface-modified two-dimensional MXene of claim 9, wherein Formula 4 is selected from the group consisting of the following Formula 4-4 to 4-13 and a combination thereof:

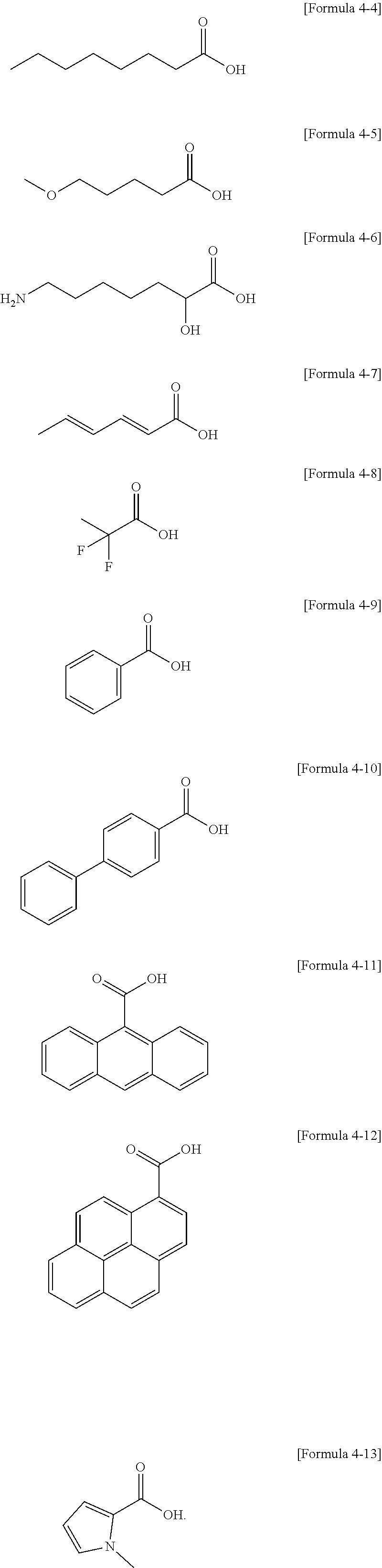

11. The surface-modified two-dimensional MXene of claim 4, wherein the sulfonic acid-based compound is the following Formula 5: 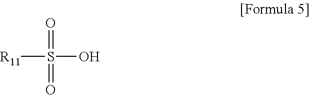
R₁₁ is a substituted or unsubstituted linear or branched alkyl group having 1 to 10 carbon atoms, a substituted or unsubstituted linear or branched alkenyl group having 2 to 10 carbon atoms, a substituted or unsubstituted linear or branched dienyl group having 2 to 10 carbon atoms, a substituted or unsubstituted cycloalkyl group having 3 to 15 carbon atoms, a substituted or unsubstituted aryl group having 6 to 20 carbon atoms, a substituted or unsubstituted anthracenyl group, a substituted or unsubstituted pyrenyl group, a substituted or unsubstituted pyridinyl group, a substituted or unsubstituted thiophenyl group, a substituted or unsubstituted furanyl group, a substituted or unsubstituted pyrazolyl group, a substituted or unsubstituted pyrrolyl group, a substituted or unsubstituted benzothiophenyl group, a substituted or unsubstituted benzimidazole group and a substituted or unsubstituted dihydrobenzofuran group.

12. The surface-modified two-dimensional MXene of claim 11, wherein Formula 5 is selected from the group consisting of the following Formula 5-1 to 5-13 and a combination thereof:

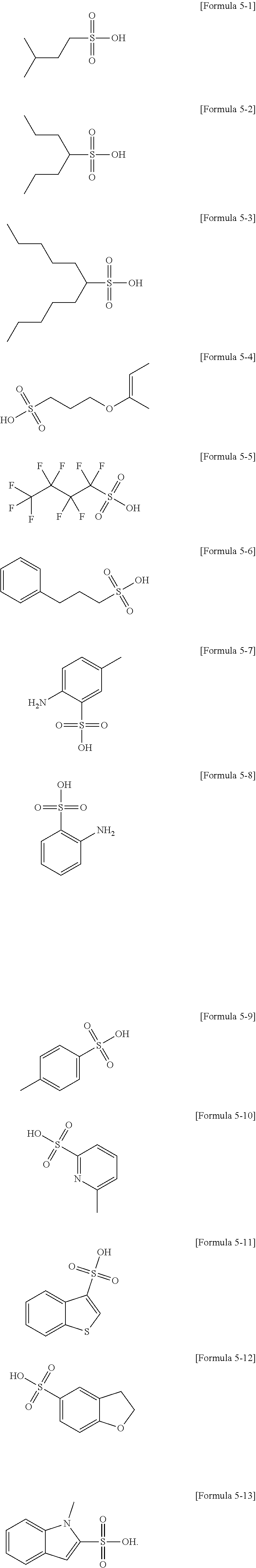

13. The surface-modified two-dimensional MXene of claim 4, wherein the sulfinic acid-based compound is the following Formula 6:

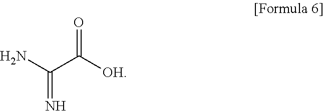

14. The surface-modified two-dimensional MXene of claim 1, wherein the ionic compound includes a cation selected from the group consisting of an imidazolium-based compound, a pyridinium-based compound, an ammonium-based compound, a phosphinium-based compound and a combination thereof; and an anion selected from the group consisting of F⁻, Cl⁻, Br⁻, I⁻, BF₄⁻, PF₆⁻, (CF₃SO₂)₂N⁻, CF₃SO₃⁻, C₂N₃⁻, CH₃SO₃⁻, CF₃BF₃⁻, C₂F₅BF₃⁻, NO₃⁻, CF₃CO₂⁻, C₃H₅O₃⁻, C₇H₅O₂⁻ and a combination thereof.

15. The surface-modified two-dimensional MXene of claim 14, wherein the cation is one selected from the group consisting of the following Formula 7 to 9 and a combination thereof: 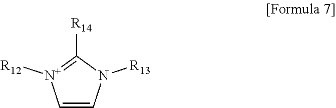
R₁₂, R₁₃ and R₁₄ are each hydrogen, a substituted or unsubstituted linear or branched alkyl group having 1 to 15 carbon atoms, and a substituted or unsubstituted linear or branched alkenyl group having 2 to 10 carbon atoms, 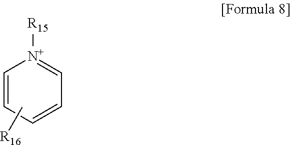
R₁₅ and R₁₆ are each hydrogen and a substituted or unsubstituted linear or branched alkyl group having 1 to 15 carbon atoms, 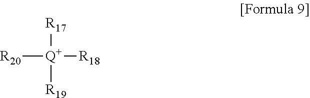
Q is N or P; and
R₁₇, R₁₈, R₁₉ and R₂₀ are each a substituted or unsubstituted linear or branched alkyl group having 1 to 15 carbon atoms.

16. The surface-modified two-dimensional MXene of claim 15, wherein Formula 7 is one selected from the group consisting of the following Formula 7-1 to 7-10 and a combination thereof;
Wherein Formula 8 is one selected from the group consisting of the following Formula 8-1 and 8-2 and a combination thereof; and
Wherein Formula 9 is one selected from the group consisting of the following Formulae 9-1 to 9-6 and a combination thereof:

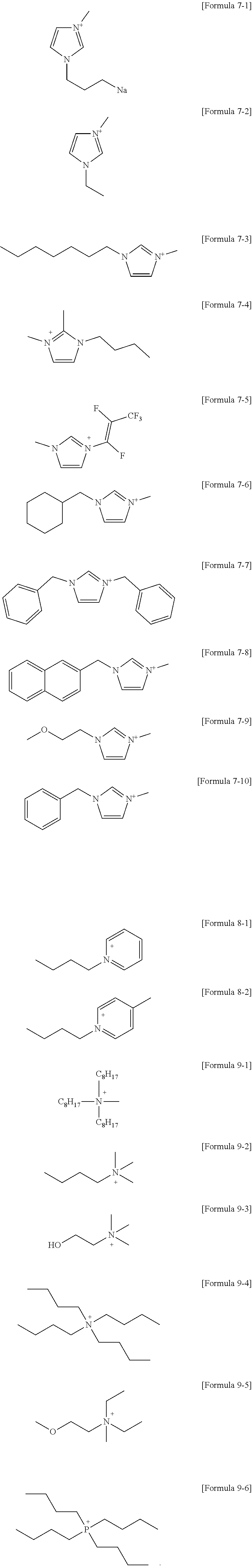

17. A method for manufacturing the surface-modified two-dimensional MXene of claim 1, the method comprising:
a first step of obtaining an aqueous MXene solution in which the two-dimensional MXene is dispersed using an acid etching process;
a second step of preparing a mixture in which one selected from the group consisting of a compound including at least one hydroxyl group, an ionic compound and a combination thereof is dispersed in water or an organic solvent; and
a third step of modifying an outer surface of the two-dimensional MXene by mixing the aqueous MXene solution obtained in the first step and the mixture of the second step and stirring the result.
